(19) United States
(12) Patent Application Publication
(10) Pub. No.: US 2008/0091128 A1
(43) Pub. Date: Apr. 17, 2008

(54) Massage apparatus with an elastic massage actuator

(75) Inventor: Simon Siu Man Nan, Richmond Hill (CA)

Correspondence Address: GREENSFELDER HEMKER & GALE PC, SUITE 2000, 10 SOUTH BROADWAY, ST LOUIS, MO, 63102, US

(73) Assignee: Nanma Manufacturing Co. Ltd., Industrial City (HK)

(21) Appl. No.: 11/581,263

(22) Filed: Oct. 16, 2006

(51) Int. Cl. A61H 1/00

(52) U.S. Cl. 601/70; 601/46

(57) ABSTRACT

A massage apparatus having a massage actuator operatively engaged to a flexible tube that is adapted to be bent is disclosed. The flexible tube is made from a flexible and elastic material that produces a biasing force when placed in a bent position such that the flexible tube is biased to its original unbiased position by the inherent biasing force generated by the flexible tube when bent.

### FIELD

The present document relates to a massage apparatus, and more particularly to a massage apparatus with an elastic massage actuator.

### SUMMARY

In an embodiment, the massage apparatus system may include a main unit, the main unit including a battery housing engaged to a holding member, the holding member engaged to a control cap adapted to control the operation of the massage apparatus when rotated; a massage actuator for providing a vibration massage function, the massage actuator being in operative association with the control cap; and a hollow, flexible tube having a distal end and a proximal end, the distal end being engaged to the massage actuator and the proximal end engaged to the main unit, wherein the hollow, flexible tube may be placed between a biased bent position such that a biasing force is generated and an original unbiased position when no biasing force is generated by the flexible tube.

In another embodiment, the massage apparatus system may include a main unit having a battery housing with at least one battery operatively disposed therein for providing power to the massage apparatus, the main unit being engaged to a holding member at one end and a flexible tube defining annular rings at an opposite end thereof, the flexible tube being of hollow construction and being engaged to a massage actuator for providing a vibration function, wherein the flexible tube being bendable from an original unbiased position such that no biasing force is produced to a biased bent position such that a biasing force is produced which attempts to bias the flexible tube back to the original unbiased position.

In yet another embodiment, a method of applying a biasing force to a massage apparatus may include:

a) providing a massage apparatus comprising a main unit having a battery housing with at least one battery operatively disposed therein for providing power to the massage apparatus, the main unit being engaged to a holding member at one end and a flexible tube at an opposite end thereof, the flexible tube being engaged to a massage actuator for providing a vibration function, wherein the flexible tube being bendable from an original unbiased position to a biased bent position such that a biasing force is generated by said flexible tube; and

b) applying an external force to the massage apparatus such that said flexible tube is placed in the biased bent position and produces the biasing force.

Implementation of the above embodiments may include one or more of the following features:

The biasing force is generated when the flexible tube is placed in the biased bent position.

The flexible tube is a metallic spring.

The flexible tube is made from a flexible and elastic material that produces the biasing force when placed in the bent position.

The control cap controls the operation of the massage actuator.

The control cap is rotated to control the operation of the massage actuator.

The massage actuator comprises an electric motor having a rotatable motor shaft, the motor shaft having an eccentric mass rotatably mounted on the motor shaft such that rotation of the motor shaft causes the eccentric mass to rotate and produce the vibration function.

The biasing force biases the flexible tube back to the original unbiased position.

An external force applied to the flexible tube or the massage actuator bends the flexible tube such that the biasing force is produced by the flexible tube.

The biasing force is generated by the flexible tube as long as the flexible tube is bent.

The biasing force biases the flexible tube when an external force is applied to the massage actuator.

The biasing force is generated as long as the flexible tube is in the biased bent position.

The biasing force biases the flexible tube back to the original unbiased position.

The method further comprising the step of removing the external force from the massage apparatus causes said flexible tube to return to the original unbiased position by the biasing force.

No biasing force is produced by the flexible tube when the flexible tube returns to the original unbiased position after the step of removing the external force.

Additional objectives, advantages and novel features will be set forth in the description which follows or will become apparent to those skilled in the art upon examination of the drawings and detailed description which follows.

### BRIEF DESCRIPTION OF THE DRAWINGS

FIG. 1 is a perspective view of the massage apparatus;

FIG. 2 is a perspective view of the massage apparatus shown in the bent position;

FIG. 3 is an exploded view of the massage apparatus; and

FIG. 4 is a cross-sectional view of the massage apparatus taken along line 4-4 of FIG. 1.

Corresponding reference characters indicate corresponding elements among the view of the drawings.

### DETAILED DESCRIPTION

Referring to the drawings, a massage apparatus is illustrated and generally indicated as 10 in FIGS. 1-4. In one embodiment, massage apparatus 10 may include a main unit 11 operatively engaged to a massage actuator 16 through a hollow, flexible tube 18 that provides a means for bending the massage actuator 16 when an external force 100 is applied to either the massage actuator 16 or flexible tube 18 as shall be discussed in greater detail below.

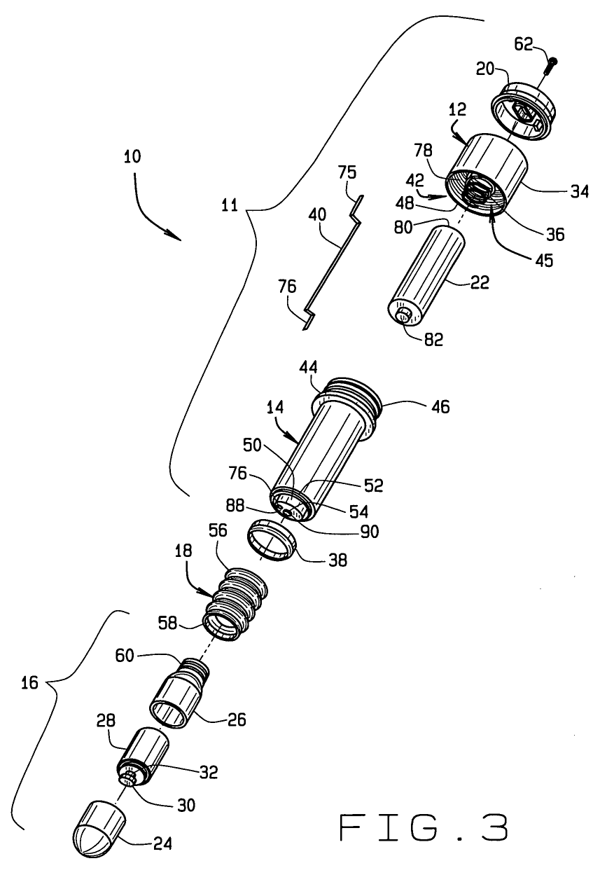

As illustrated in FIG. 1, main unit 11 may include a holding member 12 engaged at one end to a battery housing 14 for providing power to massage apparatus 10 and engaged at an opposite end to a control cap 20 for controlling the operation of massage apparatus 10. Battery housing 14 may provide a gripping surface when flexible tube 18 is bent while also being operatively associated with a battery 22 (FIG. 3) encased inside battery housing 14 for providing power to massage apparatus 10.

Referring to FIG. 3, control cap 20 allows the user to control the operation of massage apparatus 10 and may be mounted to one end of holding member 12 by screw 62. In one embodiment, rotation of the control cap 20 activates the massage actuator 16 such that continual rotation of control cap 20 increases the degree of vibration generated by the massage actuator 16.

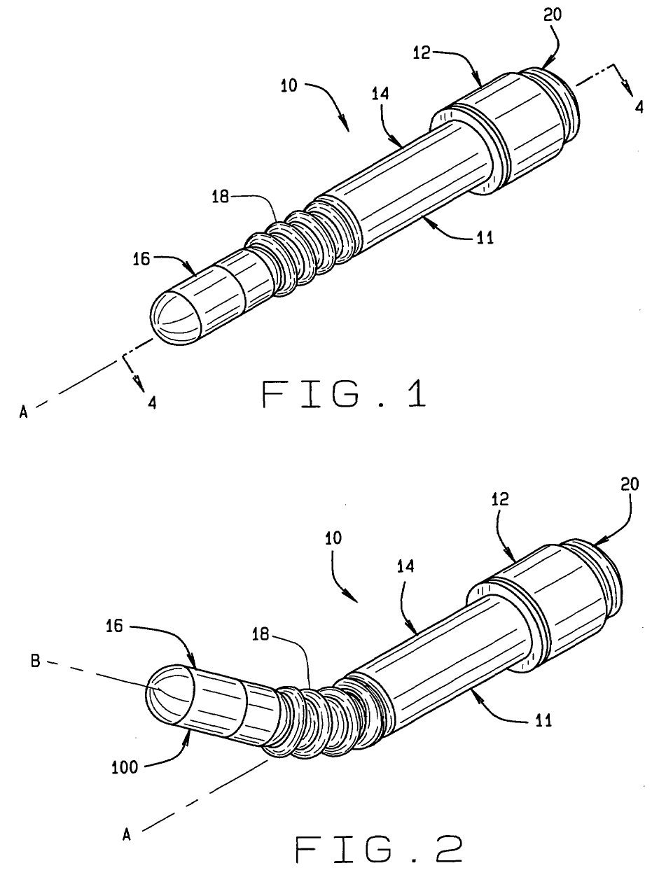

As shown in FIG. 2, flexible tube 18 in its original unbent and unbiased position is oriented along an axis A when no external force 100 is applied to either the massage actuator 16 or flexible tube 18. Flexible tube 18 may be bent such that massage actuator 16 is oriented along an axis B or any other desired axis as long as a continual external force 100 is applied to either flexible tube 18 or massage actuator 16. This bent orientation may also be achieved by pressing either the flexible tube 18 or massage actuator 16 against another structure, such as a body part, so that the natural elasticity of the flexible tube 18 produces a biasing force. In one embodiment, flexible tube 18 may have a hollow construction made of a flexible and elastic material which permits the flexible tube 18 to be bent as well as produce a biasing force in a bent orientation.

In another embodiment flexible tube 18 may be made of a metallic spring for providing substantially the same flexibility and elasticity that permits massage actuator 16 to be similarly bent when external force 100 is applied to massage apparatus 10 or pressed against an object or body part. The inherent flexible and elastic nature of the flexible tube 18 allows the flexible tube 18 to return to its original unbent position along axis A once the external force 100 is removed from the massage apparatus 10 which permits the biasing force to bias the flexible tube 18 back to the original unbiased position.

Referring back to FIG. 3, holding member 12 may include a casing 34 having an opening 42 in communication with a chamber 45 that defines an internal surface 78. The interior surface 78 may define internal threads 48 for engaging battery housing 14. A compression spring 36 may be mounted inside chamber 45 and engaged to a conductive metallic pole 40 that forms a part of a conductive electrical circuit with battery 22 as shall be discussed in greater detail below.

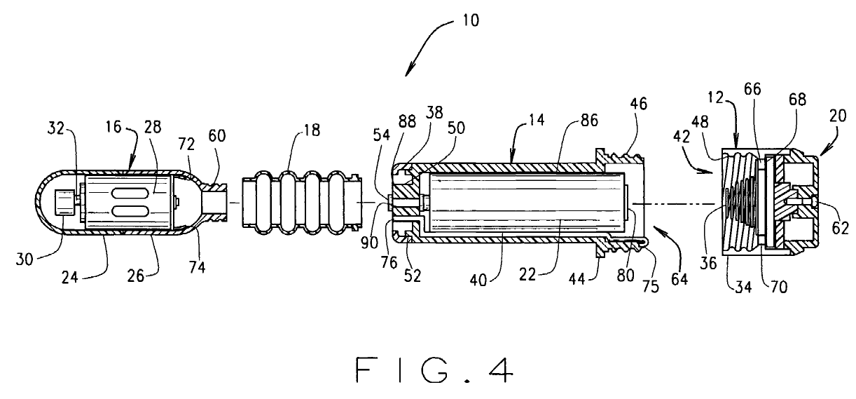

Referring to FIGS. 3 and 4, battery housing 14 may define a chamber 86 adapted to receive battery 22 having a negative terminal 80 and a positive terminal 82. In addition, battery housing 14 may include a flange 44 with external threads 46 defined adjacent flange 44 which are adapted to engage internal threads 48 of holding member 12 when engaging battery housing 14 to holding member 12 during assembly of massage apparatus 10.

As further shown, conductive metallic pole 40 may define a proximal portion 75 engaged to compression spring 36 and a distal portion 76 that extends outwardly from battery housing 14 for establishing an electrical circuit for massage apparatus 10. In addition, the electrical circuit may further include a conductive metallic pole 54 operatively engaged to the positive terminal 82 of battery 22, while the negative terminal 80 of battery 22 may be operatively associated with the distal portion 75 of metallic pole 40 through its conductive engagement with compression spring 36.

Battery housing 14 may also include an inner boss 50 that defines pair of holes 88 and 90 having conductive metallic pole 54 extending outwardly from the center hole 88 and distal portion 76 of conductive metallic pole 40 extending outwardly from the off-center hole 90. In addition, an outer boss 52 may concentrically surround inner boss 50 and may be adapted to engage a clamping ring 38 that secures the battery housing 14 with the circular portion 56 of flexible tube 18 during assembly of massage apparatus 10.

In one embodiment, flexible tube 18 may be made from a flexible and elastic material that produces a natural biasing force when the flexible tube 18 is bent by external force 100, or pressed against an object or body part to produce such an external force 100. This natural biasing force biases the flexible tube 18 back to its original unbiased position along axis A and also provides a controllable massage pressure when the massage actuator 16 is bent along axis B, or any other suitable axis, and placed against a body part. As used herein, the term “bent” means any flexed position assumed by flexible tube 18 other than the original unbiased position along axis A. As such, flexible tube 18 provides a massage apparatus 10 with a bendable massage actuator 16 that produces a biasing force when bent due to the inherent material composition of the flexible tube 18. In addition, flexible tube 18 may define a plurality of annular rings 47.

In another embodiment, flexible tube 18 may have a hollow tubular construction having a metallic spring (not shown) either embedded in the flexible tube 18 or operatively disposed inside the flexible tube 18 such that flexible tube 18 exhibits similar flexibility and elasticity of the other embodiment. As with the other embodiment, the biasing force produced by the metallic spring biases the flexible tube 18 back to its original unbiased position along axis A. If desired, metallic spring may be covered by a flexible coat.

As further shown, massage actuator 16 may include an electric motor 28 having a rotatable motor shaft 32 with an eccentric mass 30 securely mounted on the motor shaft 32. Rotation of the motor shaft 32 by the electric motor 28 causes the eccentric mass to spin and generate a vibration function. Electric motor 28 may be disposed inside an upper casing 24 engaged to a lower casing 26 which vibrates when the massage actuator 16 is made operational.

When assembling the massage apparatus 10, flexible tube 18 may be engaged to the battery housing 14 by inserting the circular portion 56 defined by flexible tube 18 over the outer circumference of outer boss 52. The circular portion 56 protrudes radially outward around the flexible tube 18. Once the circular portion 56 is so attached, a clamping ring 38 may be engaged to the circular portion 56 in order to secure the flexible tube 18 to the battery housing 14.

The opposite end of the flexible tube 18 may define an opening 58 attached to an annular portion 60 defined by the lower casing 26 of massage actuator 16. However, either end of the flexible tube 18 may be attached first during assembly of the massage apparatus 10.

During assembly, electric wires (not shown) may connect conductive metallic poles 40 and 54 to respective terminals 72 and 74 of electric motor 28 for providing electric power from the battery 22 to the electric motor 28 in order to actuate massage actuator 16. In one embodiment, electric wires may be disposed inside the hollow construction of flexible tube 18.

A pair of sliding stripes 68, 70 may be operatively engaged with variable resistance elements (not shown) and encased inside holding member 12. These pair of sliding stripes 68, 70 may be operatively engaged to control cap 20 for establishing a control arrangement that controls the operation of the massage apparatus 10, and in particular the electric motor 28. In one embodiment, rotation of the control cap 20 may gradually increase the degree of vibration produced by the massage actuator 16, while in another embodiment the degree of vibration generated by electric motor 28 may be the same as the control cap 20 is rotated to a position that actuates massage actuator 16.

It should be understood from the foregoing that, while particular embodiments have been illustrated and described, various modifications can be made thereto without departing from the spirit and scope of the invention as will be apparent to those skilled in the art. Such changes and modifications are within the scope and teaching of this invention as defined in the claims appended hereto.

1. A massage apparatus comprising:
a main unit, said main unit including a battery housing engaged to a holding member, said holding member engaged to a control cap adapted to control the operation of the massage apparatus when rotated;
a massage actuator for providing a vibration massage function, said massage actuator being in operative association with said control cap; and
a hollow, flexible tube having a distal end and a proximal end, said distal end being engaged to said massage actuator and said proximal end engaged to said main unit, wherein said hollow, flexible tube may be placed between a biased bent position such that a biasing force is generated and an original unbiased position when no biasing force is generated by said flexible tube.

2. The massage apparatus according to claim 1, wherein said biasing force is generated when the flexible tube is placed in the biased bent position.

3. The massage apparatus according to claim 1, wherein said flexible tube is a metallic spring.

4. The massage apparatus according to claim 1, wherein said flexible tube is made from a flexible and elastic material that produces said biasing force when placed in said bent position.

5. The massage apparatus according to claim 1, wherein said control cap controls the operation of said massage actuator.

6. The massage actuator according to claim 5, wherein said control cap is rotated to control the operation of said massage actuator.

7. The massage apparatus according to claim 1, wherein said massage actuator comprises an electric motor having a rotatable motor shaft, said motor shaft having an eccentric mass rotatably mounted on said motor shaft such that rotation of said motor shaft causes said eccentric mass to rotate and produce said vibration function.

8. The massage apparatus according to claim 1, wherein said biasing force biases said flexible tube back to said original unbiased position.

9. The massage apparatus according to claim 1, wherein an external force applied to said flexible tube or said massage actuator bends said flexible tube such that said biasing force is produced by said flexible tube.

10. The massage apparatus according to claim 1, wherein said biasing force is generated by said flexible tube as long as said flexible tube is bent.

11. A massage apparatus comprising:
a main unit having a battery housing with at least one battery operatively disposed therein for providing power to the massage apparatus, said main unit being engaged to a holding member at one end and a flexible tube defining annular rings at an opposite end thereof, said flexible tube being of hollow construction and being engaged to a massage actuator for providing a vibration function, wherein said flexible tube being bendable from an original unbiased position such that no biasing force is produced to a biased bent position such that a biasing force is produced which attempts to bias said flexible tube back to said original unbiased position.

12. The massage apparatus according to claim 11, wherein said biasing force biases said flexible tube when an external force is applied to said massage actuator.

13. The massage apparatus according to claim 11, wherein said biasing force is generated as long as said flexible tube is in said biased bent position.

14. The massage apparatus according to claim 11, wherein said flexible tube is made from a flexible and elastic material that produces said biasing force when said flexible tube is in said biased bent position.

15. The massage apparatus according to claim 11, wherein said biasing force biases said flexible tube back to said original unbiased position.

16. The massage apparatus according to claim 11, wherein said flexible tube is a metallic spring.

17. A method of applying a biasing force to a massage apparatus comprising:
a) providing a massage apparatus comprising a main unit having a battery housing with at least one battery operatively disposed therein for providing power to the massage apparatus, said main unit being engaged to a holding member at one end and a flexible tube at an opposite end thereof, said flexible tube being engaged to a massage actuator for providing a vibration function, wherein said flexible tube being bendable from an original unbiased position to a biased bent position such that a biasing force is generated by said flexible tube; and
b) applying an external force to said massage apparatus such that said flexible tube is placed in said biased bent position and produces said biasing force.

18. The method according to claim 17, further comprising the step of removing said external force from said massage apparatus causes said flexible tube to return to said original unbiased position by said biasing force.

19. The method according to claim 18, wherein no biasing force is produced by said flexible tube when said flexible tube returns to said original unbiased position after said step of removing said external force.
